(19) United States
(12) Patent Application Publication
(10) Pub. No.: US 2008/0183826 A1
(43) Pub. Date: Jul. 31, 2008

(54) System and Method For Transactional, Addressable Communication

(76) Inventor: Ranjit Notani, Southlake, TX (US)

Correspondence Address: HAYNES AND BOONE, LLP, 901 Main Street, Suite 3100, Dallas, TX, 75202, US

(21) Appl. No.: 11/669,660

(22) Filed: Jan. 31, 2007

(51) Int. Cl. G06F 15/16

(52) U.S. Cl. 709/206; 709/236

(57) ABSTRACT

A system allowing for a transactional, addressable communication over a network is disclosed. In one embodiment, the system comprises a first node connectable to the network for generating a message and a second node connectable to the network for receiving the message. The message is individually addressable over the network. The message comprises an address section, a metadata section, and a content section, and at least one section of the message is modifiable after the second node has received the message. Changes to a modifiable section of the message persist. In other embodiments, methods for creating and updating transactional, addressable communications are also disclosed.

### BACKGROUND

Electronic mail (“email”) is a store-and-forward system allowing multiple people to compose, send, receive, and store electronic messages over a network. Email has become a critical business and social tool used for everything from the exchange of letters to the negotiation of business documents. By most estimates email is the most popular and crucial method of communication over the internet.

The term “email” applies both to messaging systems based upon the Simple Mail Transfer Protocol (SMTP) as well as to intranet groupware systems, such as Microsoft Exchange, which do not use the same protocols and storage formats as traditional SMTP mail servers, but are interoperable with SMTP systems and present the same interface as traditional email programs.

Email is message-oriented—that is, pieces of information are formatted and sent around in discrete chunks, each known as an “email” or an email message. These messages are usually composed on a client computer in a mail user agent (MUA) or in the context of a browser for webmail. The user's content is then wrapped in an envelope of headers containing metadata about the message. The wrapped message is then handed to an SMTP server which routes the message to other SMTP servers in the delivery path. Typically, the sender retains a copy of the message in a “Sent Messages” folder and the receiver receives a copy in his or her Inbox. The receiver can then store the message, or create a new message from the contents of the received message by “replying” or “forwarding” the message.

### SUMMARY

A system allowing for a transactional, addressable communication over a network is disclosed. In one embodiment, the system comprises a first node connectable to the network for generating a message and a second node connectable to the network for receiving the message. The message is individually addressable over the network. The message comprises an address section, a metadata section, and a content section, and at least one section of the message is modifiable after the second node has received the message. Changes to a modifiable section of the message persist. In other embodiments, methods for creating and updating transactional, addressable communications are also disclosed.

### BRIEF DESCRIPTION OF THE DRAWINGS

FIG. 1 is a diagram illustrating a collaboration model using email.

FIG. 2 is a diagram illustrating a collaboration model using a transactional, addressable communication system in accordance with one embodiment.

FIG. 3 is a diagram illustrating a transactional, addressable communication system in accordance with one embodiment.

FIG. 4 is a diagram illustrating the user interface of a transactional, addressable communication client in accordance with one embodiment.

FIG. 5 is a diagram showing the different parts of a transactional, addressable message in accordance with one embodiment.

FIG. 6 is a flowchart illustrating the creation of a transactional, addressable message in accordance with one embodiment.

FIG. 7 is a flowchart illustrating the modification of a transactional, addressable message in accordance with one embodiment.

### DETAILED DESCRIPTION

Various embodiments of the present disclosure provide a novel messaging infrastructure and internet application that is a departure from the store-and-forward, message-oriented nature of conventional email, including improvements directed toward collaboration. Collaboration can be modeled as a series of interactions undertaken to reach some goal or conclusion. For example, organizing a party is one example of collaboration under this model. The party organizer interacts with prospective party participants to inform them about the prospective party, negotiate times and places, and receive confirmations about attendance.

FIG. 1 illustrates an attempt at collaboration using a traditional email system. In this example, a user 110 initiates a communication exchange by sending a set of duplicate email messages 130 to prospective participants 120a, 120b, and 120c to inform them of the start of the collaboration. The participants 120 a-c generally respond with separate email messages 140a, 140b, and 140c including information about availability, attendance, etc. Each of the messages 140a-c is a distinct and unique entity, and none of the messages 140a-c bear any programmatic relationship to each other nor to the original message 130. The user 110 (the party organizer in this example) manually collates the responses to determine who is coming and who is not. In a further example, assume that the proposed time or date is not acceptable to all. In this example, the users 110 and 120a-c may send further messages 150 and 160 between themselves. Note that with each new message that is sent out, the amount of “noise” in the system from potentially conflicting information increases. In extreme cases, continuing the collaboration may in fact create more confusion and uncertainty about the party because there is no single definitive source of information.

Another example of collaboration using a traditional email system is the joint creation or revision of a document. Again with reference to FIG. 1, user 110 and participants 120a-c are authors of the document, and interact to produce on a single conceptual work that is the result of multiple authors. Using email, this collaboration typically involves the various authors emailing copies of the document back and forth with new revisions, represented by the messages 130a-c, 140a-c, 150 and 160. Because email is message-oriented, each revision creates a new copy. This not only wastes storage space, but also uses the authors' time and effort to manually reconcile the various versions and avoid dropping revisions.

Some embodiments of the present disclosure refer to a specialized type of collaboration, called commerce. Email can be used to send invoices and orders, negotiate contracts, and communicate between businesses and customers. As with other types of collaboration, email is used because of its ubiquity and ease-of-use. Other solutions (such as EDI) are non-ubiquitous, specialized and highly complex, putting them out of reach of all but the biggest organizations.

Unfortunately, the nature of email presents legal, technical, and business difficulties when used for commerce. First, email does not provide an authoritative audit trail. While it is possible for independent parties to keep their own audit trail, the copy-oriented nature of email makes it is difficult or even impossible to prove that any single party has a complete record of the exchange. However, legal requirements such as the ones imposed by Sarbanes-Oxley may require authoritative audit trails that cannot be altered, as well as issue tracking and participant verifiability. None of these can be provided reliably through email. Therefore, many documents that need to have legal effect cannot be transmitted over email; paper or facsimile copies must still be exchanged, increasing complexity, storage cost, and time.

Second, email messages can be spoofed, edited, or otherwise injected into the exchange by malicious parties. Even in carefully controlled networks, the inherent exposure of email systems to attack creates business risk and puts legal verifiability in question. As networked commerce becomes more prevalent, the risk of using email will increase, especially when negotiating large or important transactions.

Third, email is lacking important Quality of Service (QoS) guarantees. There is no provision for guaranteed delivery of an email message, nor is there the ability to guarantee that a particular series of messages will be delivered in a particular order. Unreliable email can reduce sales or cause damage to a business' reputation if exchanges with customers are lost, misdirected, or mishandled. In the context of a collaborative effort, poor QoS may result in version clash—when multiple incompatible versions of a document exist without any simple way of reconciling the contents.

Fourth, email is not addressable—that is, email cannot be referred to across or even within some systems. Therefore, users frequently resort to poor substitutes for message addresses, such as datestamps within the email, version numbers in the title, and statements within the message itself. This presents a particular problem in commerce when one statement (such as an invoice) needs to refer to another statement (such as an order). Accurate message linking is difficult enough that the current state of the art is to inject metadata (such as tracking numbers) into the body of the message to improve the accuracy of heuristic systems. However, the injection of metadata into the email is error-prone and insufficient, especially when several distinct message threads need to unambiguously refer to a single upstream message.

Fifth, the easy automation of email systems without corresponding controls has led to a massive increase in “SPAM”—unsolicited commercial email. Recent advances (such as DomainKeys, SenderID, certified email, etc.) have attempted to address this problem, but the email system as currently architected is vulnerable to abuse. The resulting flood of spam costs money both in terms of network and processor load as well as operator time. Further compounding this problem is the ability, mentioned above, for email to be spoofed; spammers regularly modify their email messages to disguise their origins.

Because it is difficult for email to handle these seemingly simple collaboration and commerce challenges, specialized services have evolved to address use cases for which email is unfit. However, the creation of more and more specialized services to address specific uses cases imposes costs of its own. Businesses lose the ubiquity of email and must deal with the inevitable friction of multiple systems working in subtly or wholly incompatible ways.

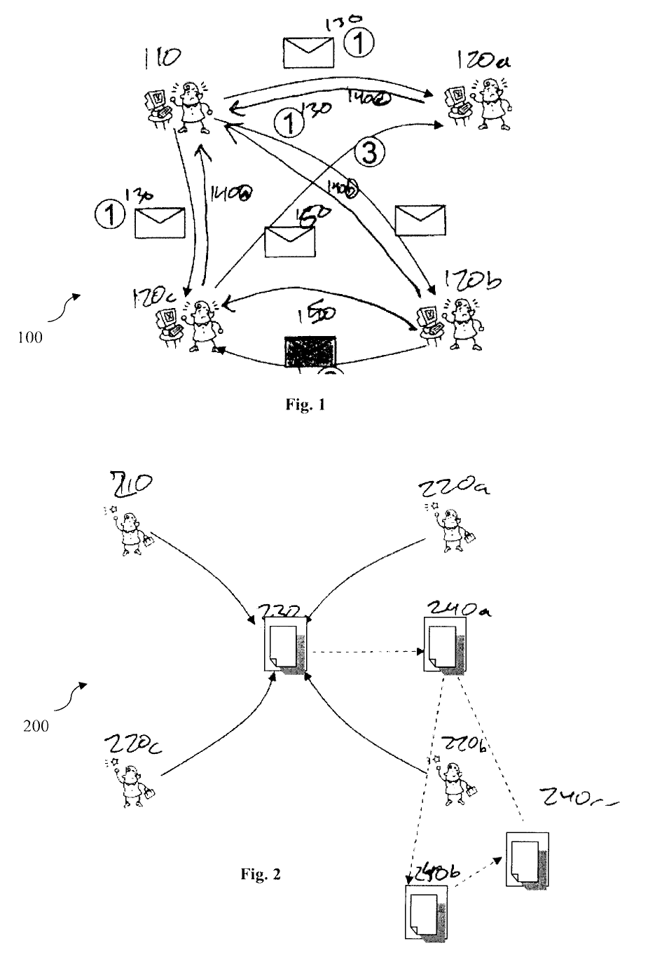

Turning to FIG. 2, various embodiments in the present disclosure provide a transactional communication system with addressable component parts. For clarity of presentation only, various legacy systems will be referred to as “email” systems and messages and various embodiments in the present disclosure will be referred to individually and collectively as “TAMM” (Transactional, Addressable Mail Messages/Transactional, Addressable Mail Messaging systems). However, it is understood that each embodiment of a TAMM is separate unless two or more embodiments are specifically linked. Returning again to the collaboration model illustrated above, user 210 wants to collaborate with users 220a-c. Instead of sending multiple copies of the same email, however, a single authoritative document—the TAMM 230—is created. In one embodiment, the TAMM 230 exists at the site of user 210's TAMM client; the client software or hardware contains modules allowing it to provide TAMM service and storage as well as the ability to read or manipulate the TAMM. In another embodiment, a separate non-client TAMM server is shared between the different participants. In a third embodiment, different parts of the TAMM are associated with different users' TAMM clients; the TAMM system associates the different portions of the TAMM over the network to present a unified interface to each participant. When each user wishes to engage in the collaboration, the joint TAMM is updated with each person's contributions, subject to constraints and permissions more fully described below. If additional pieces of information are needed in the collaboration, other TAMMs 240a-c can be created and linked to the original TAMM 230. In this embodiment, different conceptual pieces of work can be bound together while still preserving an authoritative shared repository.

To better illustrate the advantages and features of various embodiments, a particular description of several embodiments will be provided with reference to the attached drawings. These drawings, and other embodiments described herein, only illustrate selected aspects of the embodiments and do not limit the scope thereof. Further, despite reference to specific features illustrated in the example embodiments, it will nevertheless be understood that these features are not essential to all embodiments and no limitation of the scope thereof is thereby intended. Possible alterations, modifications, and applications of the principles described herein, such as would occur to one skilled in the art, have been omitted for clarity and brevity; nevertheless, it is understood that such alterations, modifications, and applications are contemplated. Some items are shown in a simplified form or are illustrated as being in direct connection for the sake of simplicity. Despite the apparent direct connection, it is understood that such illustration does not preclude the existence of intermediate components not otherwise illustrated.

For further clarity, some embodiments may use computing “modules” in their implementation. A computing module is a piece of hardware or software that can store data, process instructions, or respond to inputs. A module may be general-purpose or it may have dedicated functions such as memory management, program flow, instruction processing, object storage, etc. Modules can be implemented in any way known in the art. For example, in one embodiment a module is implemented in a hardware circuit comprising custom VLSI circuits or gate arrays, off-the-shelf semiconductors such as logic chips, transistors, or other discrete components. One or more of the modules may also be implemented in programmable hardware devices such as field programmable gate arrays, programmable array logic, programmable logic devices or the like.

In another embodiment, one or more of the computing modules are implemented in software for execution by various types of processors. An identified module of executable code may, for instance, comprise one or more physical or logical blocks of computer instructions that may, for instance, be organized as an object, procedure, or function. Further, the executables of an identified module need not be physically located together, but may comprise disparate instructions stored in different locations that, when joined logically together, comprise the module and achieve the stated purpose for the module. A “module” of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set or may be distributed over different locations including over different storage devices, and may exist, at least partially, merely as electronic signals on a system or network.

Another embodiment uses higher-level components as modules. For example, a module may comprise an entire computer acting as part of a larger system. A module may also comprise an off-the-shelf or custom program, such as a database management system. These higher-level modules may be decomposable into smaller hardware or software modules corresponding to different parts of a software program and identifiable chips (such as memory chips, ASICs, or a CPU) within a computer.

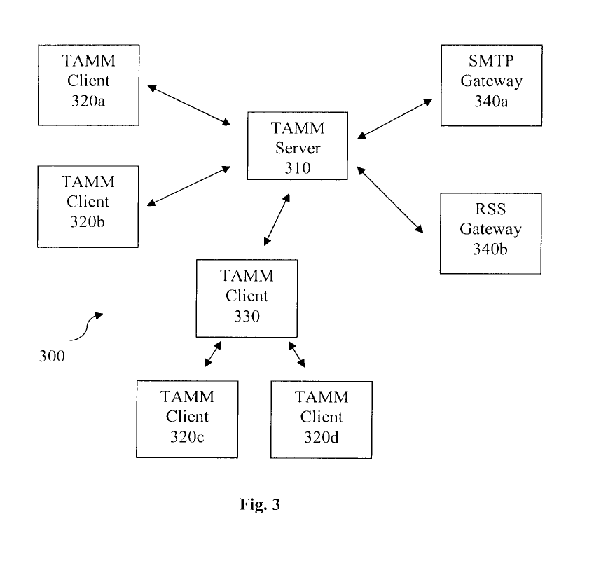

Turning to FIG. 3, one embodiment of a TAMM system is pictured generally at 300, consisting of a TAMM server 310, TAMM clients 320, a TAMM client-server 330, and one or more gateways 340. Module 310 is a TAMM server that provides storage for one or more logical collections of TAMMs. In one embodiment, this server comprises a database module, a network publishing module, and one or more interpreter modules. Clients communicate with the server either via an internal (same process), system-level (same system), or network-level API. In one embodiment different capabilities are available at different API levels. On a network level, one embodiment uses an enhanced SMTP to transfer TAMM messages and references. Another embodiment uses HTTP as a transport and defines one or more access protocols (such as WebDAV) on top of HTTP. In a third embodiment, a special-purpose protocol is used to communicate between different parts of the TAMM system. A fourth embodiment “tunnels” TAMM information through another protocol. Although a classic client-server architecture is illustrated, n-tier systems are also contemplated.

Modules 320a-d are TAMM clients. In one embodiment, these clients are traditional software programs. In another embodiment, these clients are libraries or modules that other programs or modules call into to interact with the TAMM system. In a third embodiment, all or part of a client module 320 is delivered over the network. One embodiment of a client module is discussed in more detail below.

The module 330 is a client-server module. In one embodiment, this module serves as a “bridge” server, proxying requests back to the TAMM server 310. In another embodiment, the module 330 acts as a full server. The client modules 320c and 320d may or may not be aware that the client/server module 330 has a connection with another TAMM system. In a third embodiment, only part of the TAMM system service is “served” from the client/server module 330. Rather, the module 330 acts as a tracker, describing the location of various parts of the TAMM and directing how the component parts can be assembled logically into a single cohesive unit.

The modules 340a and 340b are gateways, allowing interoperability with outside systems, particularly email systems. Module 340a acts as an SMTP gateway, taking TAMMs and formatting them as compliant email messages. In one embodiment, this formatting is lossless, and the TAMM is able to tunnel through the SMTP system into another TAMM-compliant system. In another embodiment, this transformation is lossy, and an email representation of the TAMM is created, but programmatic links with the TAMM are lost. In a third embodiment, a “reference” email is created, which email notifies the receiver that a TAMM has been created and invites him or her to log into the TAMM system to view and interact with that TAMM. Module 340b acts as an RSS gateway, allowing notifications via paging over HTTP and web-based interaction.

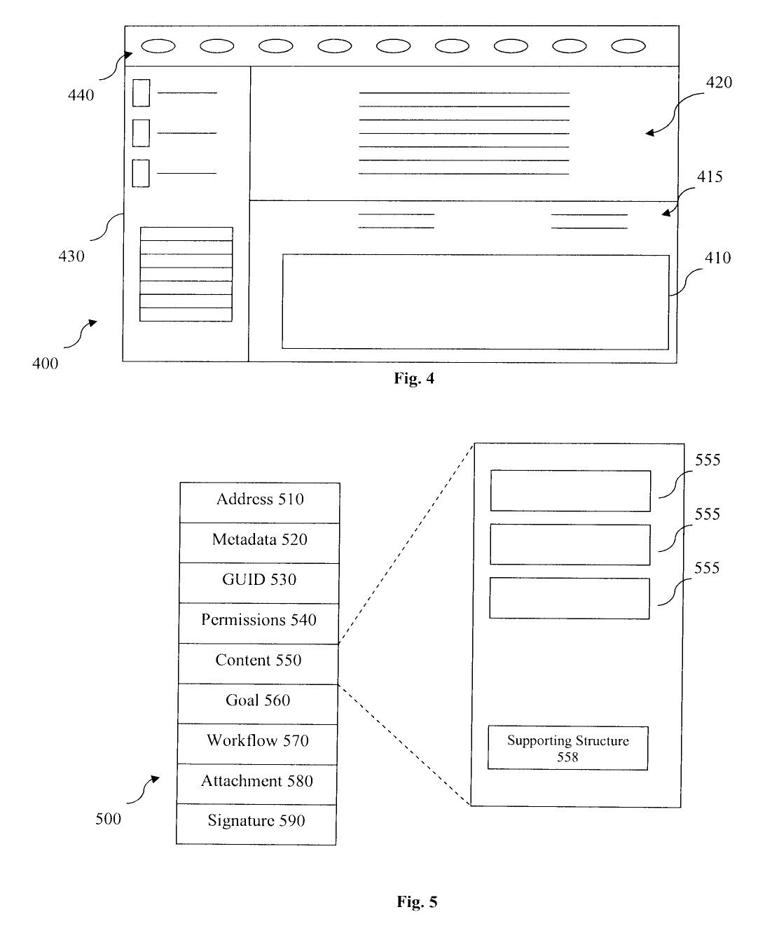

Turning to FIG. 4, the user interface of one illustrative client module is generally referenced by the number 400. In this embodiment, the user interface is provided by a traditional “thick client” module, similar to an email client program. In another embodiment, the user interface is defined in a file sent over the network, such as an HTML or XML document; a local rendering module draws the interface.

A three pane interface is denoted by the areas marked 410, 420, and 430. Area 410 is the message pane, adapted to display the current TAMM as well as present tools for working with the specific TAMM type. Section 415 presents an area in which metadata about the TAMM may be displayed or manipulated. Area 420 is the list pane, adapted to display different groups of TAMMs filtered and organized in different ways. For example, one embodiment presents a threading view. Another embodiment presents a list view organized and sortable by date, originator, last participant, TAMM status, and other metadata. A third embodiment uses a graph view to describe connections between TAMMs and allow manipulation and viewing of interconnected TAMMs. A fourth embodiment expands a single TAMM to show the interactions within that TAMM. A fifth embodiment allows several types of views, including the views stated above, to be optionally employed. Area 430 is a grouping pane, adapted to show and focus on the organization of different TAMM collections. For example, one embodiment uses different levels of generality to organize TAMMs, such as “private,” “group,” “company,” and “anyone.” Another embodiment uses a hierarchical or graph structure to link groups of TAMMs. A third embodiment uses various sortable lists and a paging mechanism. A fourth embodiment uses a search interface to locate “tagged” TAMMs. TAMMs retrieved through the search mechanism are presented in a list below the search box. The final area, marked 440, is a global application toolbar in which different common tools are presented for working with the TAMM system or with individual TAMMs. For example, one embodiment includes a “compose” toolbar allowing one-click creation of TAMMs.

In one embodiment, many apparent views of the TAMM are provided through the use of TAMM references. These references are “personalized views” on a TAMM, and can be transparently used as if they were actually the TAMM, even though the actual TAMM is only stored in one place. In different embodiments, TAMM references may have different attributes associated with them. For example, one set of TAMM references are used to track the read/unread status of TAMMs. In another embodiment, references are used to implement tagging and categorization operations. In a third embodiment, references are used to allow offline readers to “download” TAMM information for disconnected use. In a fourth embodiment, references are used to notify others about the existence of a TAMM.

Turning to FIG. 5, the various parts of a TAMM are represented. In one embodiment, the different parts of a TAMM are never stored as a contiguous unit; rather, they are brought together into a logical unit through logical association, linking, joining, or other processes. In a second embodiment, the TAMM is stored as a single file in a specific format. This format could be a superset of the RFC 2822 and 2045 standards that define internet message formats and MIME attachments. In one embodiment, for example, the information could be included by adding extra headers or specialized MIME attachments that would be preserved (but not interpreted) by email clients and email systems. The format could alternatively be a vender-specific textual, tagged, or binary format. In a third embodiment, different TAMM formats could be transparently used within the same system to promote interoperability with email systems and clients while still providing advanced functionality to TAMM-native clients. In a fourth embodiment, TAMMs are stored as rows in joined tables in a relational database.

It will be appreciated by those skilled in the art that a TAMM can be instantiated as an email, and some embodiments of TAMM can define the functionality of a TAMM system as a strict superset of the functionality of existing email systems. Further, an embodiment can define a TAMM format so that TAMM-specific information is passed through traditional email systems intact. In another embodiment, email is used as a TAMM notification mechanism, and specialized links associate the content of an email with a specific TAMM. In embodiments where interoperability with email has been established, some or all of the functionality of email is reproduced—including the advantages of ubiquity and familiarity. Thus, in some embodiments, a TAMM address can be used interchangeably with an email address. Unstructured interactions, such as those using email, are available with the same ease-of-use as in existing systems. At the same time, however, the higher structure of the TAMM allows interactions not previously possible with email.

Continuing with FIG. 5, one embodiment of TAMM contains an address section 510, a metadata section 520, a globally unique ID (guid) 530, a permissions section 540, a content section 550, a goal section 560, a workflow/application section 570, and a signature section 580. Other embodiments may use different sections. For example, one embodiment adds an “attachment” section. Another embodiment allows user-defined sections for use in specialized TAMM interactions. Also, not all sections are required for each TAMM—some sections may be optional or have system-provided default values.

The address section 510 contains references to one or more recipients. These recipients will receive notification of the TAMM and may have permission to modify, link to, see, or otherwise access the TAMM. In one embodiment, the recipients are identified by TAMM addresses or by other URIs. In another embodiment, no-recipient TAMMs are allowable and can be used by their author to track the status of other TAMMs or groups of TAMMs. In a third embodiment, the address section can contain references to other TAMMs—i.e., a TAMM can itself be the recipient of a message. In a fourth embodiment, the address section contains references to addresses without holding the addresses themselves, allowing the TAMM addresses to be opaque to a user or author. In a fifth embodiment, the address section holds addresses or references to groups of users. A sixth embodiment uses the concept of logical databases. Logical Databases are “spaces” where TAMMs can be directed to allow them to be accessed as a group by any member of the logical database. For example, all task TAMMs may be directed to a “Project” logical database where they can be dealt with collectively. A seventh embodiment allows two or more different types of recipients in the address section.

In one embodiment, each recipient in the address section is linked to a unique identity. The authentication of participants can be scaled to allow different types or levels of privilege depending on the quality of the authentication. For example, Sarbanes-Oxley compliance may require participant verification. A TAMM could require authentication of a recipient to fulfill that requirement. Alternatively, authentication could be used to enforce rules concerning unwanted distribution of SPAM while still allowing programmatic access and automation of the TAMM system.

The metadata section 520 contains metadata about the TAMM, including an optional subject. The information in the metadata section does not necessarily need to be hard-coded; one embodiment has active content in the metadata section to modify the metadata in response to changes in the current TAMM or one or more linked TAMMs. Many different types of metadata can be contained within the metadata section. Depending on the embodiment, this metadata may be key-value structured, table-structured, or tree-structured. The metadata section may also include interpretation information to aid TAMM clients in the interpretation of application-specific and custom TAMM types.

The guid 530 allows each TAMM to be individually addressed. In one embodiment, each TAMM client has a designated number range within the TAMM space defined by 0.2¹²⁸. The system assigns each TAMM a number serially from within the range. In another embodiment, the guid is generated using TAMM-client-specific, machine-specific, and time-specific data. In a third embodiment, each guid 530 is a unique URI. With the URI space, different URIs could refer to different levels of the TAMM infrastructure. In one exemplary embodiment, global TAMMs are referred to via a URI [http://node.com/gTAMM/<logical database number>/<TAMM-number>], and organization-centric TAMMs are referred to via a URI [http://node.com/oTAMM/<org number>/<logical database number>/<TAMM-number>].

Different embodiments can use the guid 530 to provide services within the TAMM system. For example, one embodiment uses the guid to provide unambiguous threading and linking between TAMMs. Another embodiment uses the guid to make each TAMM reachable over the web. A third embodiment uses the guid to make archiving and retrieving TAMM fine-grained and exact. A fourth embodiment uses the guid to link TACs (Transactional, Addressable Chats) to a temporal schedule. A fifth embodiment uses the guid to create a shared, authoritative audit trail.

In one embodiment implementing an audit trail, each guid 530 in a particular exchange is part of a cryptographic message hash. Only the correct content in the correct order can produce an equivalent hash value. In another embodiment, each guid is a key in a multi-key signing system, with each message being signed and possibly encrypted using the guids from previous TAMMs in the exchange. The participant's keys can also be optionally included. In this embodiment, only the participation of each principal as well as the inclusion of each TAMM in the exchange, in order, can successfully reveal or authenticate the most recent TAMM message.

The permissions section 540 contains security information concerning the content of the TAMM and the links contained therein. In one embodiment, this security information takes the form of capabilities. Each individual part of the TAMM is defined to have certain capabilities as defined in the literature; security can be implemented as a reachability constraint or via the presence or absence of tokens.

In another embodiment, the security information takes the form of ACLs that can be edited by the author and those to whom the author grants ACL editing permissions. Users that have access to one TAMM can be allowed to access a related TAMM through a special grant of privilege. This grant can be non-transitive in nature.

In a third embodiment, the permissions section 540 contains role information. A role-based system is a system in which identities and resources are managed by aggregating them into “roles” based on job functions, physical location, legal controls, and other criteria. These roles can be used to model organizational structures, manage assets, or organize data. By arranging roles and the associated rules into graphs or hierarchies, these roles can be used to reason about and manage various resources.

Role-based strategies can be used in the context of a security model called Role-Based Access Control (RBAC). RBAC associates special rules, called “permissions,” with roles; each role is granted only the minimum permissions necessary for the performance of the functions associated with that role. Identities are assigned to roles, giving the users and other entities the permissions necessary to accomplish job functions. This presents a flexible approach while still maintaining separation of duties concepts important to real-world security. In one TAMM embodiment, roles, organizations, and identities are all first-class objects within the TAMM manipulable by the TAMM system.

In a fourth embodiment, the permissions section 540 is part of a public key infrastructure (PKI) system; the security of any individual part of a TAMM is predicated on being able to decrypt and interpret that part.

In a fifth embodiment, the type of the TAMM (as discussed below) defines certain permissions over different parts of content. For example, an “accept” permission may make sense in one type of TAMM, but not in another. The permissions section 540 is flexible enough to allow the definition of new permission types upon the creation of a TAMM.

The content section 550 contains one or more content blocks 555 and optional supporting structure 558. In one embodiment, each TAMM contains a single block of content 555, as in current email. In another embodiment it contains multiple blocks of content in an order defined by the supporting structure 558. For example, one of the layout options for the list pane 420 allows a single TAMM to be expanded to show its constituent parts. In the context of such an embodiment, a single TAMM acts as a self-contained record of a conversation. In one embodiment, each content block 555 has an internal reference number in the supporting structure 558 to allow specific parts of a TAMM conversation to be referenced. The internal references may have a simple ordering, such as a straight temporal ordering, or the ordering may be more complex, such as a tree or graph.

One particular type of content block 555 is the link. A link may refer to other parts of the same TAMM, to other TAMMs, to subsections in other TAMMs, or to other URIs. In one embodiment, a TAMM link can be defined in terms of the direction information can travel using the link. For example, one embodiment uses standard links that allow the two-way travel of content and focus (user attention). Another embodiment only allows data to travel along the link, whereas a third link only allows the transfer of focus (user attention). A fourth embodiment defines directional links; data or focus can only travel one way on the link. A fifth embodiment defines a permissioned link—a link that only allows travel if the correct user is using the link. To preserve permissions, a sixth embodiment uses two-sided links—links in which the outgoing link (in the current document) and the incoming link (in the linked document) cooperatively control the behavior of the link. If the two sides of the link do not agree, the link can only be used to the extent of the lesser permissions.

The goal section 560 allows a TAMM to have a “direct object” that the other “verb” or “noun” parts of the TAMM can refer to. In one embodiment, the goal section 240 is manipulated collaboratively in a joint edit metaphor. In another embodiment, the goal section is manipulated serially in a workflow metaphor. The precise manipulation mechanism depends on the implementation details in each embodiment and the type of the TAMM as discussed below. In other embodiments, the goal section 540 acts as similarly to the content section 550 discussed above, with integral content blocks and supporting structures—the difference existing in the interpretation of the section by the user as opposed to the implementation of the section.

One particular embodiment uses the goal section 560 to facilitate a “shared page” metaphor between participants. The shared page is the authoritative repository for content and information about a particular transaction. Because all participants in the TAMM exchange are able to work from the same worldview, email failings such as multiple storage of an object and version clash can be avoided.

The workflow/application section 570 may contain one or more code modules, permitting active content to be embedded within a TAMM. These code modules can be sandboxed to allow the safe execution of semi-trusted or untrusted instructions within the context of a TAMM. For example, one embodiment uses embedded JavaScript code or java archives within the workflow/application section. The TAMM client module includes an interpreter module that can access and interpret the embedded code. This embedded code can programmatically access and modify the contents of the email in a manner defined by the TAMM author. In one embodiment, the structure of the TAMM is defined by an XML DOM. The code modules are able to manipulate the DOM and so affect the TAMM. In another embodiment, the code modules are instructions allowing calls out to a TAMM API defined in the broader TAMM environment. Each call can be checked for safety before it is executed.

The signature section 580 allows portions or all of the TAMM to be signed. In one embodiment, these signatures are just strings indicating consent or acceptance of the contents of the email, such as s/John Jones/. In other embodiments, these signatures are cryptographic signature functions capable of verifying that one or more parts of the TAMM have not been altered. In some embodiments, TAMM client modules have built-in support for signing TAMMs as well as verifying the signatures of other participants.

Those skilled in the art will notice that there are no inherent restrictions on what is in the TAMM. Similarly, there are no inherent restrictions on the authorship of each portion of a TAMM. The permissions section 540 may place limits on the contents or authorship in any particular TAMM, but those restrictions are not inherent to the system.

The ability for a single TAMM to encompass multiple authors and multiple content blocks allows certain embodiments to embrace metaphors other than that of email. For example, one embodiment is a TAC, an alternative to traditional instant messaging and chatroom systems. Each exchange is conceptualized as a different content block 555 in a temporal order defined in the supporting structure 558. As well as serving as a full replacement for traditional chat, one embodiment uses the guid 530 and internal content references to allow each exchange within the TAC session to become a first-class member in a conceptual hierarchy defined over one or more TAMMs/TACs.

Another example of an alternative embodiment is a “live” organizational structure. The different content blocks 555 represent or link to different parts of an organizational hierarchy. Each content block uses a “pull” data link to demand-fetch its content from linked TAMMs, such that a user of the top-level organizational chart email can get a “dashboard” view of an entire organization by viewing a single TAMM.

In other embodiments, the flexibility of the content, goal, and workflow/application sections within a TAMM/TAC object allow for substantial interactivity between participants. For example, some embodiments may include “immersive” exchanges, using metaphors such as a conference, a seminar, a speech, a shared desktop, a whiteboard, an interview, a party, etc.

In some embodiments, the flexibility of individual TAMMs can be reduced to introduce greater support for structured transactions. This is known as “typing” a TAMM. In one embodiment, the typing of a TAMM allows control over the potential TAMM addressee types. In another embodiment, the type controls the (potentially attributed) structure of the content section 550 or the goal section 560. In a third embodiment, the type controls the metaphor used to edit the TAMM (joint editing, workflow, etc.). In a fourth embodiment, the type controls the permissions granted to each addressee both absolutely (for the life of the TAMM) as well as temporally (to grant and revoke permissions in a workflow-oriented TAMM).

The combination of TAMM typing and internal TAMM structure allows some embodiments to make transactional guarantees. In one embodiment, the ‘transaction’ refers to atomicity of a particular access or modification. For example, one embodiment uses a TAMM that is internally structured as a database; access to and modification of the contents is subject to ACID requirements familiar from traditional relational and object databases. In another embodiment, the ‘transaction’ refers to a business transaction. In this embodiment, a business transaction refers to a particular document which maintains integrity constraints throughout its life-cycle. For example, one embodiment uses an invoice-typed TAMM to track a particular purchase. The workflow/application section 570 includes a well-defined lifecycle for the TAMM defined in terms of a state machine. The invoice can only be manipulated subject to the constraints imposed by the state machine. In this embodiment, only structured attributes are allowed, and the transactional TAMM contains within the content blocks 550 an authoritative audit trail recording each manipulation. In a third embodiment, a particular TAMM is subject to both business transaction rules and ACID constraints.

Many types of TAMMs are contemplated. For example, one embodiment uses a “standard” TAMM. This TAMM is analogous to an email thread in that it is designed to start a discussion about some subject.

Another embodiment defines a “notification” TAMM. This TAMM notifies a particular addressee about something. The notification TAMM may or may not be updateable. An updateable notification allows the notification to be updated after creation. A non-updateable notification does not allow the notification to be updated after creation. For example, one embodiment of an updateable notification contains information about a meeting. Whenever the meeting information changes (location or time), the notification can be updated.

Another embodiment defines an “agreement request” TAMM. The purpose of agreement request is to achieve agreement on some point. For example, a user may be trying to reach agreement on the time of a meeting or on contract terms. The agreement request may be modeled as a single or a multi-round negotiation, with the goal section containing the continually updated tentative agreement. In an exemplary embodiment, a designated addressee “coordinator” is able to execute an update agreement action. Negotiators can accept or decline the agreement. A single-round TAMM would only allow one opportunity to accept; a multi-round would provide an opportunity to accept or reject after each update.

Another embodiment defines a “vote” TAMM to take a poll on some issue. The vote initiator can control whether the vote is anonymous or open, as well as determining the viewability of the vote summary contained in the goal section.

Another embodiment defines an “approval” TAMM to garner approval for some course of action. For example, a person could use an approval TAMM to get a vacation request approved. In an exemplary embodiment, one user (the approval seeker) creates the TAMM. Another user (the approver) can either approve, decline or forward the approval TAMM. Another embodiment allows the approver to make one or more annotations to one or more portions of the TAMM before forwarding.

Another embodiment defines a “response requested” TAMM for RSVPing or otherwise assuring the presence or attention of another party. In one exemplary embodiment, a response requested TAMM can be automatically created to accompany some other TAMM.

Another embodiment defines a “grid” or “gridset” TAMM. In one embodiment, the purpose of a grid TAMM is to represent a grid or array data structure. Multiple grids can be created, each in its own named ‘worksheet’. If multiple worksheets are created, the embodying TAMM is called a gridset.

Another embodiment defines a “table” or “tableset” TAMM. In one embodiment, a table TAMM extends a grid to include attributed columns and ordered rows. Multiple tables can be created, each in its own named ‘worksheet’. If multiple worksheets are created, the embodying TAMM is called a tableset.

In one embodiment, a TAMM user creates an application from a table or tableset. This is done by capturing the current state of the table as a prototype of the application, with placeholder variable used to represent the possible inputs from other users. The resulting application appears as a new TAMM.

Another embodiment defines a “calendar” TAMM to represent a shared calendar between a set of users. In one embodiment, different parts of a grid are given attributes corresponding to days, weeks, months, and years. Users attach other TAMMs to different parts of the calendar grid to represent appointments, reminders, etc. In another embodiment, appointments, meetings, tasks, and projects are all individual TAMM types that can interact with, refer to, and be referred to by the calendar.

Other TAMM types are contemplated in connection with various use cases. For example, other embodiments may define photo album, playlist, map, note, order, shipment, invoice, and payment TAMMs. The flexibility of the TAMM system allows many metaphors to be instantiated into a TAMM to allow diverse structured interactions.

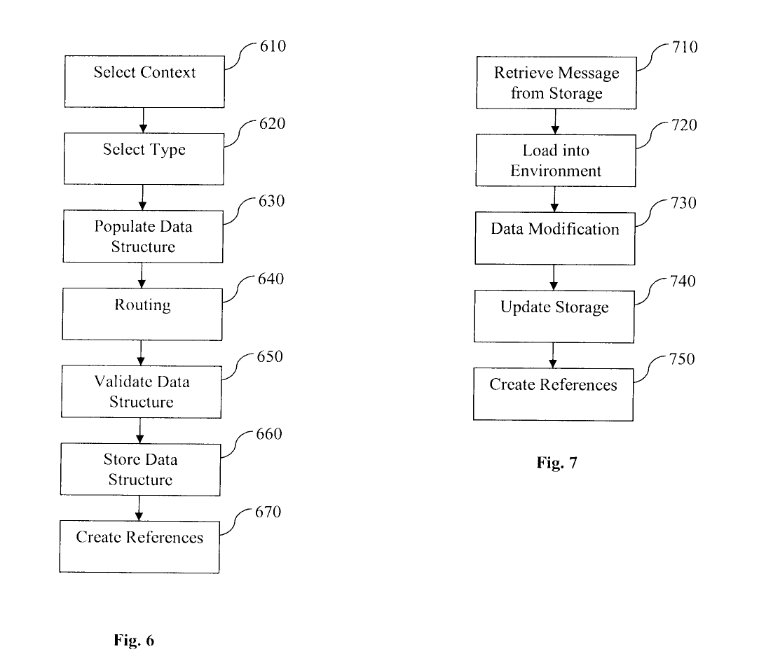

FIG. 6 is a flowchart illustrating TAMM creation according to one embodiment. At step 610, an operator selects the TAMM context. In one embodiment, this is a global context. In a second embodiment, this is an organization context. In a third embodiment, the TAMM is in an application or mini-application context. In a fourth embodiment, this is an operator-defined context. In a fifth embodiment, the TAMM has different portions that correspond to different contexts. In a sixth embodiment, the context of the TAMM is implied by the context in which the TAMM creation procedure is invoked or the context in which the TAMM user is operating.

At step 620, the operator selects the type of TAMM to create. On one embodiment, this is done through an API call. In a second embodiment, the operator is presented with a variety of options, such as a drop-down box, and the operator's choice is determined by mapping mouse clicks and key presses to active areas in the TAMM creation application. In a third embodiment, a rule engine evaluates the TAMM context to prune the available types. In a fourth embodiment, the TAMM creation application uses a default setting for the type.

At step 630, various parts of the TAMM structure are populated with data. For example, the operator can enter one or more addresses, a subject, comments, goals, attachments, and other type-specific information. In one embodiment, this is done via one or more API calls into the TAMM application. In a second embodiment, a GUI is used to present a form to an operator; the operator is able to fill in the form using a keyboard and mouse. In a third embodiment, the data is fetched from a storage module such as a database.

In a fourth embodiment, an autocompletion module assists the operator in populating the TAMM. This autocompletion module can be implemented in various ways. For example, one autocompleter fetches information, such as address information, from a central server. The GUI has a drop-down box of suggested completions for the operator to pick. Another autocompleter performs a contextual analysis and provides recommended data for various fields.

In a fifth embodiment, a scanner module performs validation or checking on provided data. For example, one scanner performs spell-checking on provided input. Another scanner does a virus check on attachments or content blocks. A third scanner parses provided data, such as XML data, for well-formedness or adherence to some outside specification.

In a sixth embodiment, an authorizer module performs one or more tests on the operator before accepting data. For example, one authorizer module presents a CAPTCHA to verify the presence of a human operator. Another authorizer processes a key, passphrase, or other cryptographic data. A third authorizer matches operator-provided data against one or more rules before accepting the data.

In a seventh embodiment, a security module encrypts one or more portions of the TAMM before or after filling in the TAMM data structure.

At step 640, a receiver module routes the TAMM to the proper destination. In one embodiment, the receiver uses a load balancer module to redirect the TAMM to the operator's “home” TAMM receiver computer, as indicated by a hidden data field in the TAMM. In a second embodiment, a peer-to-peer connection is established between the TAMM creator computer and the TAMM receiver computer. In a third embodiment, the TAMM is stored in a database allowing all subscribers to that database to instantly “see” the TAMM. In a fourth embodiment, a routing algorithm is used to pass the TAMM to the receiver computer.

At step 650, the receiver computer validates the TAMM. In one embodiment, the validation is done via a session verification module. The session verification module uses information embedded in the TAMM to verify the operator's session information, including authentication and authorization information. In a second embodiment, the content of the TAMM, including any state engines in the Workflow/Application section 570, are validated. Embedded state engines may need to have their inputs and internal states check for consistency. Similarly, embedded signatures may be used to verify the authenticity of the TAMM before it is accepted. Another implementation may verify that the TAMM obeys type-related constraints.

At step 660, the TAMM is stored by a storage module. In one embodiment, the TAMM is directed to either a “global” database of all shared TAMMs. In a second embodiment, a local storage unit, such as an organization receiver is used. For example, the TAMM is put in a data store on a receiver computer local to a particular organization or organizational unit. In another example, the TAMM is stored in the working area of an application execution environment. The TAMM incorporates the data and instructions necessary for the execution environment to “run” the TAMM as an application. In a third embodiment, the TAMM is put in a data store defined in a user-provided schema. In a fourth embodiment, “storing” the TAMM involves storing references to the different parts of the TAMM already resident on various computers. In a fifth embodiment, a guid is associated with the TAMM during storage; the guid is communicated back to the creating computer. In a sixth embodiment, storing the TAMM is not complete until an auditing record is created or updated. In a seventh embodiment, different parts of the TAMM may be put in different stores. For example, attachments may be put into a versioned file store, metadata put into a relational database, and content blocks put into a full-text database.

In step 670, one or more TAMM references are created. In embodiments which use user groups or aliases, the user groups are expanded and the aliases resolved to TAMM addresses. For each TAMM addressee, a TAMM reference is created and sent to the addressee's inbox. In one embodiment, this is done by updating a database with a flag. In another embodiment, the TAMM client software subscribes to a particular feed, such as an RSS or ATOM feed, and the TAMM reference is provided over that feed. In a third embodiment, the TAMM reference is formatted as an RFC 2822 message and passed to an SMTP server. Other embodiments may use RPC protocols such as CORBA, DCOP, XML-RPC or SOAP to communicate a TAMM reference. In general, any messaging service known in the art can be used to carry a TAMM reference or notification.

Turning to FIG. 7, one embodiment of the TAMM update procedure is illustrated. At step 710, the TAMM is retrieved. The retrieval may occur because an operator clicked on a TAMM link or TAMM reference, or the retrieval may occur because of programmatic access to the TAMM system. In one embodiment using a relational database, one or more fields serve as primary keys. The TAMM is retrieved by joining the various tables into a single data structure. In a second embodiment using an object database, the guid 530 is used as an access key for TAMM retrieval. In a third distributed embodiment, a redirector sends the retrieval request to the appropriate computer before the TAMM is retrieved.

At step 720, the TAMM is loaded into the environment. In one embodiment, a guard module is used to manage the loading of and access to the TAMM. The loading operator or process needs to be authenticated and authorized before access to the TAMM is allowed. This may occur prior to retrieving the TAMM, prior to loading the TAMM, or subsequent to loading but prior to access.

In a second embodiment, the TAMM is loaded into an application execution environment. This may be implemented by examining the state engine in the TAMM itself, or by using instructions within the TAMM to drive an external state engine. Another implementation uses the TAMM viewer application as the application execution environment, and mediates all interaction with the TAMM through that interface.

In a third embodiment using roles, the role-specific view is calculated. The permissions on different parts of the TAMM may only allow operators with certain permissions to edit, view, or otherwise interact with the restricted portions in the TAMM. The loader module calculates the viewable and actionable parts of the TAMM and only presents those parts to the operator. This may also involve changing the user interface of the TAMM, particularly for typed TAMMs. Similar views can be calculated based upon workflow state or typing information.

At step 730, data is entered into or modified in the TAMM. This may involve simple data entry, state changes within the TAMM, modification of metadata in the TAMM, or interactions with one or more applications in the Workflow/Application portion of the TAMM. In one embodiment, this is done via one or more API calls into the TAMM application. In a second embodiment, a GUI is used to present a form to an operator; the operator is able to fill in or modify the information in the form using a keyboard and mouse. Some embodiments may use autocompletion, scanner, authorizer, or security modules as described above.

At step 740, the TAMM storage is updated. Depending on the particular embodiment, this may encompass updating a “global” data store, an “organization” data store, a user-defined data store, or some combination of the above. In one embodiment a redirector module, as described above, is used to mediate the storage requests in a distributed system. Updating the TAMM storage may involve small updates to multiple data stores; for example, an update might require an UPDATE in a relational database, a reindexing in a full-text search database, a new version in a versioned file store, and various new associations in an object database.

At step 750, one or more TAMM references may need to be created. For example, a “widening” of the TAMM permissions or addressee list can result in the creation of a new TAMM reference. Another embodiment provides an audit trail by generating and recording TAMM references after each access and change to the TAMM. A third embodiment uses TAMM references for change notification or workflow routing. The creation of the TAMM references may occur as described above.

It is understood that several modifications, changes and substitutions are intended in the foregoing disclosure and in some instances some features of the embodiments will be employed without a corresponding use of other features. Accordingly, it is appropriate that the appended claims be construed broadly and in a manner consistent with the scope of the embodiments described herein.

What is claimed is:

1. A system for providing a transactional, addressable message over a network, the system comprising:
a first node connectable to the network for generating a message; and
a second node connectable to the network for receiving the message;
wherein the message is individually addressable over the network;
wherein the message comprises an address section, a metadata section, and a content section;
wherein at least one section of the message is modifiable after the second node has received the message; and
wherein a change to a modifiable section of the message persists.

2. The system of claim 1 wherein the message further comprises one of a permissions section, a goal section, a globally-unique identifier, and a signature section.

3. The system of claim 1 wherein the message further comprises a workflow/application section.

4. The system of claim 3 wherein the workflow/application section comprises one of a state machine and computer-interpretable instructions.

5. The system of claim 1 wherein the content section comprises multiple content blocks.

6. The system of claim 1 wherein the message has a type selected from a group consisting of an unstructured type, a chat type, a dashboard type, a notification type, an agreement request type, a poll type, an approval request type, a response request type, a grid type, a gridset type, a table type, a tableset type, a calendar type, a photo album type, a playlist type, a map type, a note type, an order type, a shipment type, an invoice type, and a payment type.

7. The system of claim 1 wherein the message is individually addressable over the network via a Universal Resource Identifier (URI).

8. A method for creating a transactional, addressable communication, the method comprising:
selecting a context for the communication;
selecting a type for the communication;
using the context and type to instantiate a message data structure for the communication, wherein the message data structure comprises an address section, a metadata section, and a content section;
populating the address, metadata, and content sections in the message data structure;
routing the message data structure to a destination;
validating the message data structure; and
storing the message data structure.

9. The method of claim 8 wherein the context for the communication is selected from the group consisting of a global context, an organization context, an operator-defined context, a mixed context, and an application context.

10. The method of claim 8 wherein the type for the communication is selected from a group consisting of an unstructured type, a chat type, a dashboard type, a notification type, an agreement request type, a poll type, an approval request type, a response request type, a grid type, a gridset type, a table type, a tableset type, a calendar type, a photo album type, a playlist type, a map type, a note type, an order type, a shipment type, an invoice type, and a payment type.

11. The method of claim 8 wherein populating the message data structure comprises using one of an autocompleter, a scanner, an authorizer, and a security module.

12. The method of claim 8 wherein routing the message data structure to a destination comprises using one of a redirector module, a load balancer, a peer-to-peer connection, and a routing protocol.

13. The method of claim 8 wherein validating the message data structure comprises verifying one of a session, a state engine, an embedded signature, and type constraints.

14. The method of claim 8 wherein storing the message data structure comprises putting the message data structure in one of a global data store, a local data store, a user-defined data store, the working area of an application execution environment, an audit trail, a versioned store, a full-text index, a directory, a relational database, an object database, a key-pair database, a filesystem, and a combination thereof.

15. The method of claim 8 further comprising creating a reference data structure and associating the reference data structure with the message data structure.

16. A method for interacting with a transactional, addressable message, the message having a data structure, the method comprising:
using a globally-unique identifier to locate a message data structure;
retrieving the message data structure from a storage module;
loading the message data structure into a working environment;
modifying a section in the message data structure; and
storing the modified message data structure to the storage module.

17. The method of claim 16 wherein loading the message data structure into a working environment comprises one of interacting with a state engine located inside the message data structure, interacting with a state engine located outside the message data structure, using a guard module, creating a role-specific view, creating a type-specific view, and creating a workflow-specific view.

18. The method of claim 16 wherein modifying a section in the message data structure comprises one of adding information to the section, removing information from the section, changing information in the section, changing metadata in the section, changing metadata about the section, changing permissions in the section, changing permissions on the section, interacting with a state engine located in the section, interacting with a state engine located outside the section, signing the section, encrypting the section, decrypting the section, updating an audit trail, and verifying an audit trail.

19. The method of claim 16 further comprising creating a reference data structure and associating the reference data structure with the message data structure.

20. The method of claim 19 wherein creating a reference data structure comprises updating a data store, modifying subscribed information, making an Remote Procedure Call (RPC), making an Application Programming Interface (API) call, creating a message, and creating an email.
